(19) United States
(12) Patent Application Publication
(10) Pub. No.: US 2026/0052304 A1
(43) Pub. Date: Feb. 19, 2026

(54) AI-LANGUAGE-BASED CAMERA PARAMETER GENERATION SYSTEM

(71) Applicants: SONY GROUP CORPORATION, Tokyo (JP); Sony Corporation of America, New York, NY (US)

(72) Inventor: Owen Mayer, San Jose, CA (US)

(21) Appl. No.: 19/081,770

(22) Filed: Mar. 17, 2025

Related U.S. Application Data
(60) Provisional application No. 63/683,767, filed on Aug. 16, 2024.

(51) Int. Cl. H04N 23/62; G06F 40/40

(52) U.S. Cl. CPC H04N 23/62; G06F 40/40

(57) ABSTRACT

Described herein is a language-based camera parameter generation system that sets the parameters for the ISP and/or control of a digital camera from a user-input language prompt, such that the capture and processing of the ISP matches the visual quality described by the language prompt. The camera operator provides a language-based description, such as a short sentence (for example, “dreamy and awe-inspiring image that is well exposed”) before taking a photo, and the system will generate the control and ISP parameters such that captured image or video will have visual qualities that match the language prompt. This gives a new way for the camera user to control the visual quality of the image and enables new creative expressions. The benefit of a language-based approach is that it is more natural and intuitive than manually setting numerical values.

### CROSS-REFERENCE TO RELATED APPLICATION(S)

This application claims priority under 35 U.S.C. § 119 (e) of the U.S. Provisional Patent Application Ser. No. 63/683,767, filed Aug. 16, 2024 and titled, “AI-LANGUAGE-BASED CAMERA PARAMETER GENERATION SYSTEM,” which is hereby incorporated by reference in its entirety for all purposes.

### FIELD OF THE INVENTION

The present invention relates to camera devices. More specifically, the present invention relates to adjusting parameters of camera devices.

### BACKGROUND OF THE INVENTION

Inside a typical modern digital camera is an Image Signal Processor (ISP), which processes the “RAW” capture data into an image or video that matches human visual and perceptual expectations. Typical ISPs are a sequence of algorithmic “blocks,” which each perform separate and unique functions, such as denoising, demosaicing, color corrections, white balance, gamma corrections, tone mapping, and others to produce the final image. These ISP blocks include parameters such as thresholds, coefficients, switches, and more, that specify the workings of the algorithm inside the ISP blocks. As a result, the exact settings of these ISP parameters impact the perceived visual quality and aesthetic feel of the image.

Typically, these ISP parameters are preset by the camera manufacturer. The camera user has limited control over the visual quality of the processed image through choices among presets. If situations arise where the camera user can set the ISP parameters themselves, they must manually set numerical values which often is not intuitive.

Furthermore, there are several camera control parameters or settings that the photographer uses during operation of the camera such as exposure time, aperture, ISO, and focus point. The choice of these settings also impacts the visual quality of the image (e.g., longer exposure times can impart a dramatic motion blur, larger aperture can impart a certain bokeh effect, and more), and their setting through the camera interface may not be intuitive or natural.

### SUMMARY OF THE INVENTION

Described herein is a language-based camera parameter generation system that sets the parameters for the ISP and/or control of a digital camera from a user-input language prompt, such that the capture and processing of the ISP matches the visual quality described by the language prompt. The camera operator provides a language-based description, such as a short sentence (for example, “dreamy and awe-inspiring image that is well exposed”) before taking a photo, and the system will generate the control and ISP parameters such that captured image or video will have visual qualities that match the language prompt. This gives a new way for the camera user to control the visual quality of the image and enables new creative expressions. The benefit of a language-based approach is that it is more natural and intuitive than manually setting numerical values.

In one aspect, a method programmed in a non-transitory memory of a device comprises: acquiring a language prompt, generating language-tuned camera settings based on the language prompt alone and processing image sensor data based on the language-tuned camera settings to generate a language-processed image. Generating the language-tuned camera settings is based on the language prompt and acquired sensor data. Generating the language-tuned camera settings is performed through iterative interactions between the method and an operator of the device. The language-tuned camera settings comprise Image Signal Processor (ISP) parameters. The language-tuned camera settings comprise camera control parameters. The language-tuned camera settings comprise Image Signal Processor (ISP) parameters and camera control parameters. Generating language-tuned camera settings is performed by an Artificial Intelligence (AI)-language model. The AI-language model is trained with images and corresponding language. The input image comprises a pre-captured image. The language prompt comprises speech or text. The language prompt comprises a single word, a fragment, a sentence or a paragraph. The language prompt comprises N prompts, where N>1, including a prompt and an antonym of the prompt and a user-specified ratio.

In another aspect, an apparatus comprises a sensor for acquiring an input image, a non-transitory memory for storing an application, the application for: acquiring a language prompt, and generating language-tuned camera settings based on the language prompt and the input image, a processor coupled to the memory, the processor for processing the application and an Image Signal Processor (ISP) for processing the input image based on the language-tuned camera settings to generate a language-processed image. Generating the language-tuned camera settings is based on the language prompt and acquired sensor data. Generating the language-tuned camera settings is performed through iterative interactions between the apparatus and an operator of the apparatus. The language-tuned camera settings comprise ISP parameters. The language-tuned camera settings comprise camera control parameters. The language-tuned camera settings comprise ISP parameters and camera control parameters. Generating language-tuned camera settings is performed by an Artificial Intelligence (AI)-language model. The AI-language model is trained with images and corresponding language. The input image comprises a pre-captured image. The language prompt comprises speech or text. The language prompt comprises a single word, a fragment, a sentence or a paragraph. The language prompt comprises two prompts including a prompt and an antonym of the prompt and a user-specified ratio.

In another aspect, a system comprises a camera device configured for: acquiring a language prompt and processing image sensor data based on the language-tuned camera settings to generate a language-processed image and a cloud device configured for: receiving the language prompt from the camera device, generating the language-tuned camera settings based on the language prompt alone and sending the language-tuned camera settings to the camera device. Generating the language-tuned camera settings is based on the language prompt and acquired sensor data. Generating the language-tuned camera settings is performed through iterative interactions between the camera device and an operator of the camera device. The language-tuned camera settings comprise ISP parameters. The language-tuned camera settings comprise camera control parameters. The language-tuned camera settings comprise ISP parameters and camera control parameters. Generating language-tuned camera settings is performed by an Artificial Intelligence (AI)-language model. The AI-language model is trained with images and corresponding language. The input image comprises a pre-captured image. The language prompt comprises speech or text. The language prompt comprises a single word, a fragment, a sentence or a paragraph. The language prompt comprises two prompts including a prompt and an antonym of the prompt and a user-specified ratio.

### BRIEF DESCRIPTION OF THE DRAWINGS

FIG. 1 shows a drawing of camera components according to some embodiments.

FIG. 2 shows images of various algorithm blocks of the ISP according to some embodiments.

FIG. 3 shows a diagram of AI-based ISP tuning according to some embodiments.

FIG. 4 shows a diagram of a language-based ISP tuning implementation according to some embodiments.

FIG. 5 shows a diagram of a Contrastive Language-Image Pretraining (CLIP)-based implementation according to some embodiments.

FIG. 6 shows images of various brightness according to some embodiments.

FIG. 7 shows images involved with linear matrix tuning according to some embodiments.

FIG. 8 shows images of AI-tuned color grading according to some embodiments.

FIG. 9 shows images based on abstract and emotional prompts according to some embodiments.

FIG. 10 shows images of ranges of image interpolation according to some embodiments.

FIG. 11 shows a diagram of language-based camera controls according to some embodiments.

FIG. 12 shows a diagram of language-based camera controls according to some embodiments.

FIG. 13 shows a block diagram of an exemplary computing device configured to implement the AI-language-based camera parameter generation system according to some embodiments.

FIG. 14 shows a diagram of an exemplary AI-language-based camera parameter generation system according to some embodiments.

### DETAILED DESCRIPTION OF THE PREFERRED EMBODIMENT

A camera captures raw sensor data. When the image is saved to memory, there are several processes, e.g., Image Signal Processing (ISP), that convert the raw data into human-friendly content. There are many algorithms and parameter choices in ISP that determine how the image will look. Instead of using simple toggles or sliders, the parameter generation system described herein utilizes language, such as verbal commands received by a user.

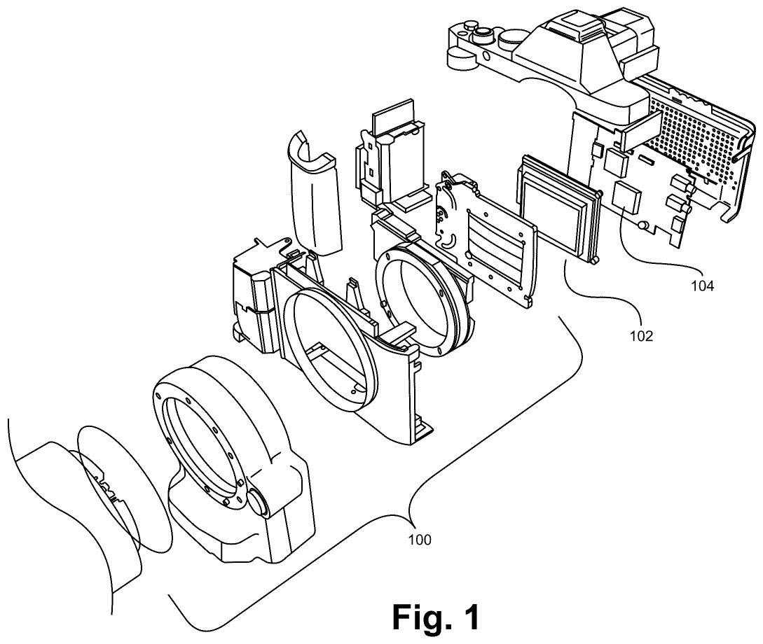

FIG. 1 shows an drawing of camera components according to some embodiments. Optics components 100 focus light onto a camera sensor 102. The camera sensor 102 converts photons into an electrical signal. An ISP 104 converts the sensor data to match the human visual system. Other camera components are able to be included.

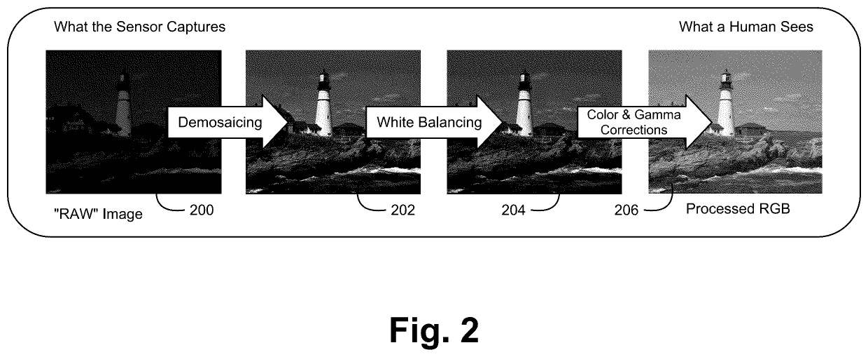

FIG. 2 shows images of various algorithm blocks of the ISP according to some embodiments. Image 200 shows the RAW image of what the sensor captures. Image 202 is the image after demosaicing is applied. Image 204 is the image after white balancing is applied. Image 206 is the processed RGB image that a human sees after color and gamma corrections. There are many other algorithms/functions that are able to be applied to the image such as noise reduction, sharpening, contrast enhancement, lens shading removal, chromatic aberration removal, and local tone mapping. Many blocks have tens to hundreds of tunable parameters, e.g. coefficients, thresholds, switches, and more.

Color and creativity are important aspects of an image. For example, color grading (adjustment) evokes certain moods and feelings. An ISP is able to perform color correction to match the sensitivity of the sensor to human vision.

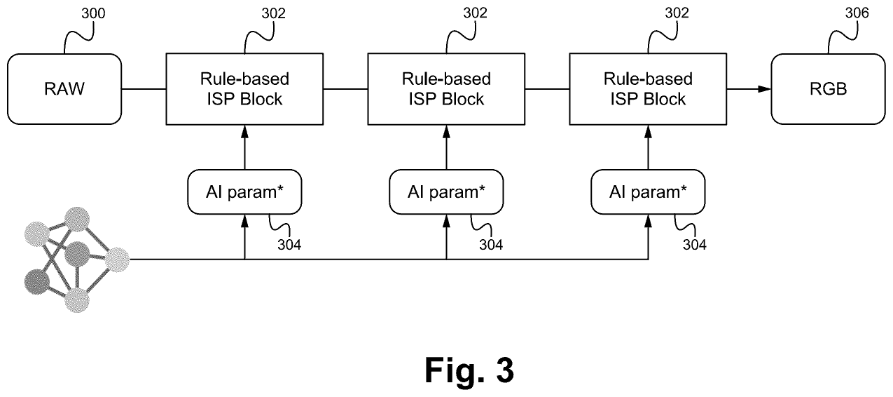

FIG. 3 shows a diagram of AI-based ISP tuning according to some embodiments. As described herein, a RAW image 300 is captured by the sensor which is processed into an RGB image 306 which is viewable by a person. The processing of the image is performed by rule-based ISP blocks 302 such as demosaicing, white balancing, noise balancing and others. The rule-based ISP blocks utilize Artificial Intelligence (AI) parameters to perform the specified algorithms/function. For example, depending on the AI parameters for noise balancing, the RGB image 306 is able to be very noisy, have very little noise, or somewhere in between.

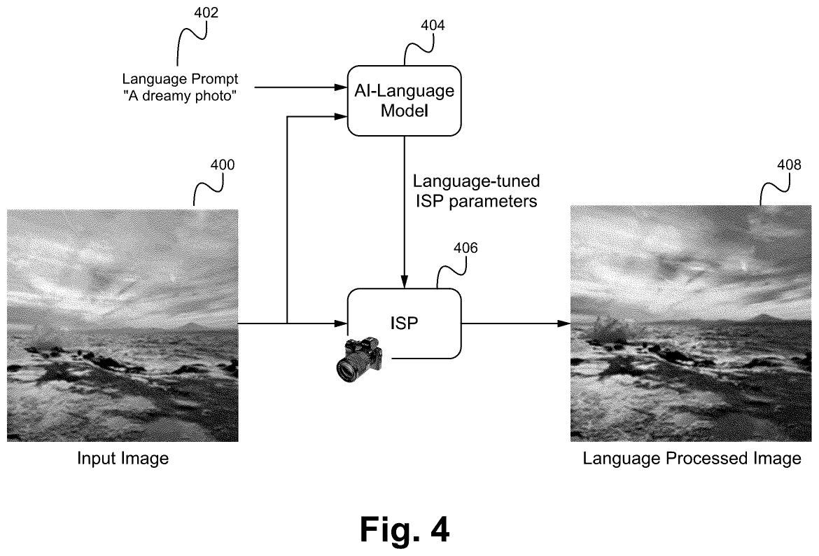

FIG. 4 shows a diagram of a language-based ISP tuning implementation according to some embodiments. An input image 400 (or image sensor data) is acquired (e.g., a user takes a picture with his camera or phone camera). The user provides a language prompt 402 (e.g., the user says, “I want a dreamy photo” which is received by the device microphone). The language prompt 402 and the input image 400 are input to the AI-language model 404. The AI-language model 404 generates language-tuned ISP parameters which are input to an ISP 406. Any ISP parameters are able to be adjusted/tuned (e.g., demosaicing, white balancing and others). Additionally, other device parameters are able to be set using a language prompt such as parameters that are set before the image is taken such as aperture (e.g., depth of field) or focus. Instead of manually setting an aperture value, the user is able to say, “I would like to take a soft focus image,” and the aperature is automatically set to an appropriate setting to acquire a soft focus image. The tuned ISP 406 then processes the input image 400 and generates a language processed image 408. In some embodiments, the order of the steps is modified. For example, the language prompt 402 is received before the input image 400 is acquired. In some embodiments, fewer or additional steps are implemented. In some embodiments, the system uses as input: a captured image and a language prompt, a pre-captured image and the language prompt, or the language prompt only.

The language-tuned camera settings are able to be generated through an iterative process between the method/device and an operator/user, for example, as a large language model-based chat. Furthering the example, an image is processed using an initial language prompt; the user is then queried if they like the image; the user responds such as “I would like the colors of [object] to be emphasized;” and new camera settings are generated.

The input language prompt is able to be spoken, text, or input in another manner. The input language prompt is able to be a single word, a few words or a sentence, a paragraph, or any level of input. The input language prompt is able to include two prompts (e.g., a prompt and its antonym) along with a user-specified ratio between them. The generated parameters are an interpolation between the two prompts relative to the specified ratio which gives the user finer control over the final visual quality.

The AI-language model 404 is able to be trained in any manner. For example, the AI-language model receives images and corresponding language. Furthering the example, a set of images with blurry backgrounds are received with a corresponding description of “blurry background.” In some embodiments, the AI-language model 404 also receives camera parameters associated with each image, and in some embodiments, the AI-language model 404 determines the camera parameters to achieve the specific image appearance by taking an original image and modifying the parameters until the desired modified image is generated. In some embodiments, the AI-language model 404 is pre-trained or uses one or more pre-trained models (e.g., a pre-trained large language model).

The AI-language model 404 is able to be stored locally on the user device (e.g., camera), remotely (e.g., in the Cloud) or a combination thereof. For example, the AI-language model 404 is stored entirely on each user device and is able to perform any training, image/parameter analysis and modification of parameters on the device. In another example, the AI-language model 404 is stored on a remote device (e.g., a server in the Cloud), and the user device communicates information (e.g., a thumbnail of an image) to the AI-language model 404 which then performs image/parameter analysis and modification, and then sends updated information (e.g., parameters) to the user device to update the local parameters to acquire or manipulate the image according to the updated parameters. In yet another example, some aspects/elements of the AI-language model 404 are stored locally on a user device (e.g., the aspect to update camera parameters) and other aspects of the AI-language model 404 are stored remotely on a server (e.g., the aspects to train the AI-language model). In another example, a camera device is connected to a phone device which is connected to a Cloud device, and any or all of these are able to implement the AI-language model 404 aspects described herein and communicate the information to the appropriate device for processing and updating.

In some embodiments, the AI-language model 404 is trained and set before being provided on a user device or cloud device. In some embodiments, the AI-language model 404 is continuously training and learning to refine the parameters to achieve desired results. For example, reinforcement learning is implemented. In another example, the training/learning is personalized for a user. Furthering the example, after a user describes a desired image (e.g., “blurry background”), the device provides two or more images to select from, where the images are the same original image but with different parameters applied. The user selects his preferred image, which is then used to refine the parameters, so that AI-language model 404 knows exactly what the user desires for each verbal command. In some embodiments, after the user confirms a specified number of images (e.g., a threshold of 5 times) with the same parameters associated with the same verbal command, the user device only provides a single image to the user, since the command and corresponding parameters are established.

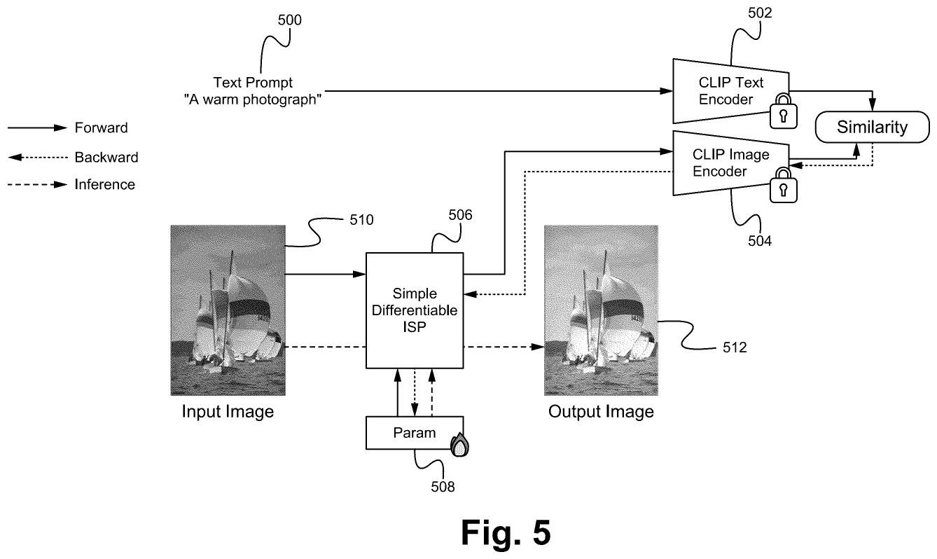

FIG. 5 shows a diagram of a Contrastive Language-Image Pretraining (CLIP)-based implementation according to some embodiments. The CLIP-based implementation uses a pair of neural network models (CLIP text encoder 502 for text understanding, and CLIP image encoder 504 for image understanding). The CLIP method trains the pair of models constrastively, where one model receives text as input and outputs a single vector representing its semantic content, and the other model receives an image and outputs a single vector representing its visual content. The models are trained so that the vectors corresponding to semantically similar text-image pairs are close together in the shared vector space.

A text prompt 500 (e.g., “a warm photograph”) is acquired and sent to the CLIP text encoder 502 and the CLIP image encoder 504. The CLIP encoders output vectors and/or other data to the ISP 506. Parameters 508 of the ISP 506 are adjusted through gradient backpropagation (represented by the “backward” dotted arrow) with respect to the text prompt 500. The ISP 506 then uses the adjusted parameters 508 to process an input image 510 (e.g., acquired by the camera) to generate an output image 512 which will have the desired appearance of a “warm photograph.” Although a CLIP implementation is described, any training/model is able to be utilized.

In an example of parameter tuning, gain optimization (e.g., parameter of “image gain”) is able to be performed. A user is able to provide a prompt of “a well exposed photo of a [sailboat race].” The brightness of the image is able to be controlled through language.

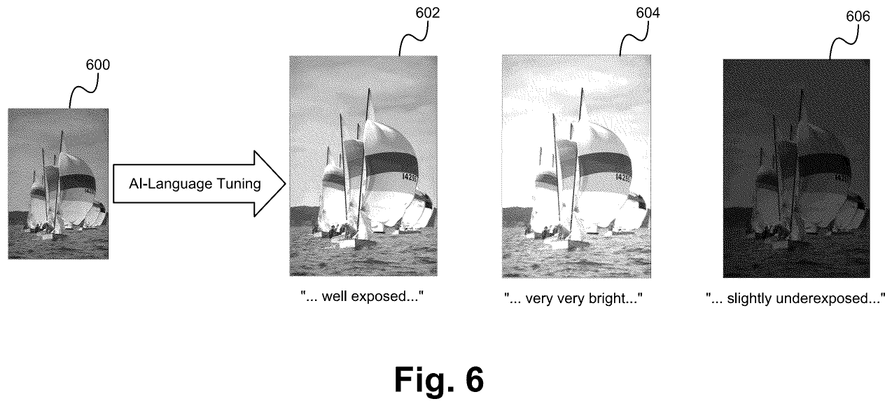

FIG. 6 shows images of various brightness according to some embodiments. An acquired image 600 is able to be processed depending on the parameters which are modified using AI-language tuning. For example, image 602 is a result of a verbal request “well exposed.” Image 604 is a result of a verbal request “very very bright.” Image 606 is a result of a verbal request “slightly underexposed.”

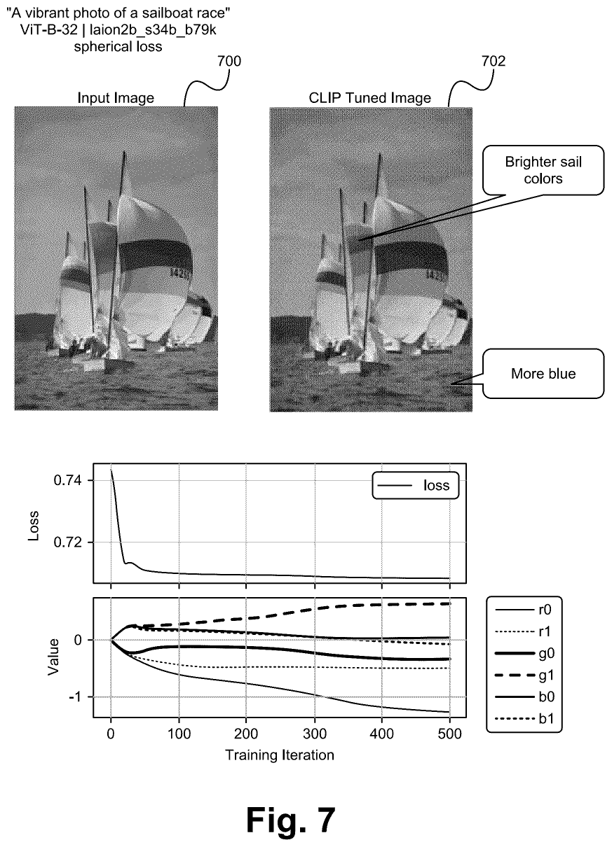

FIG. 7 shows images involved with linear matrix tuning according to some embodiments. Image 700 is the original image and image 702 is the CLIP tuned image with brighter sail colors and more vibrant blue water after a request of a “vibrant photo.” The parameters are able to be adjusted using linear matrix tuning.

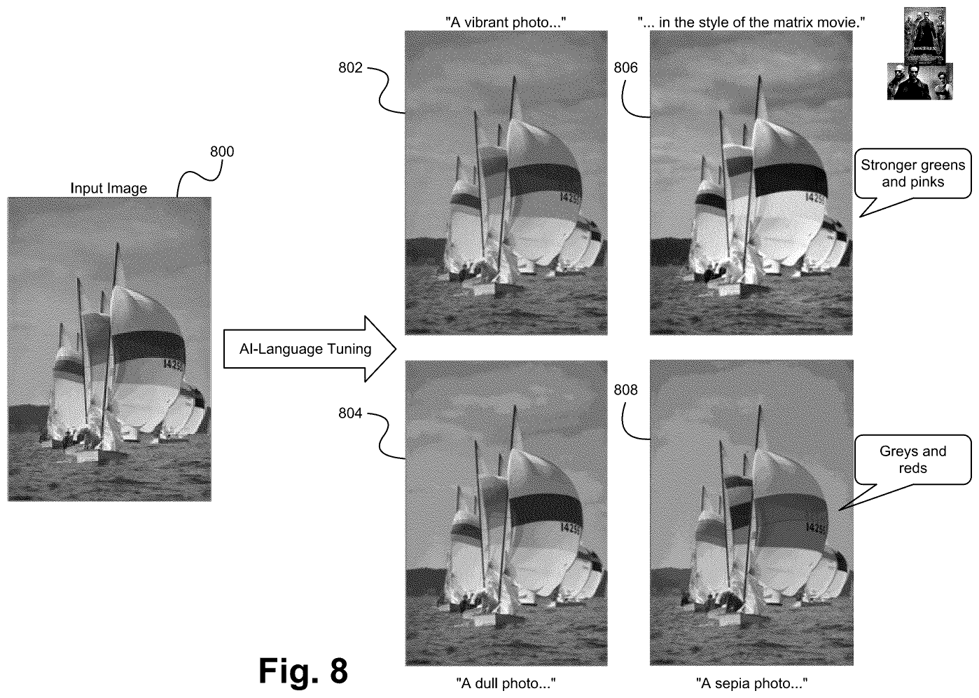

FIG. 8 shows images of AI-tuned color grading according to some embodiments. An n-parameter (e.g., n=6) color adjustment ISP block is able to be used adjust the color of images. An original image 800 is acquired. Based on the AI-language tuning, the following color adjustments are possible. For example, “a vibrant photo” request results in image 802. A request of “a dull photo” results in image 804. A request of “in the style of the Matrix movie” results in image 806 with strong greens and pinks. A request of “a sepia photo” results in image 808 with grays and reds.

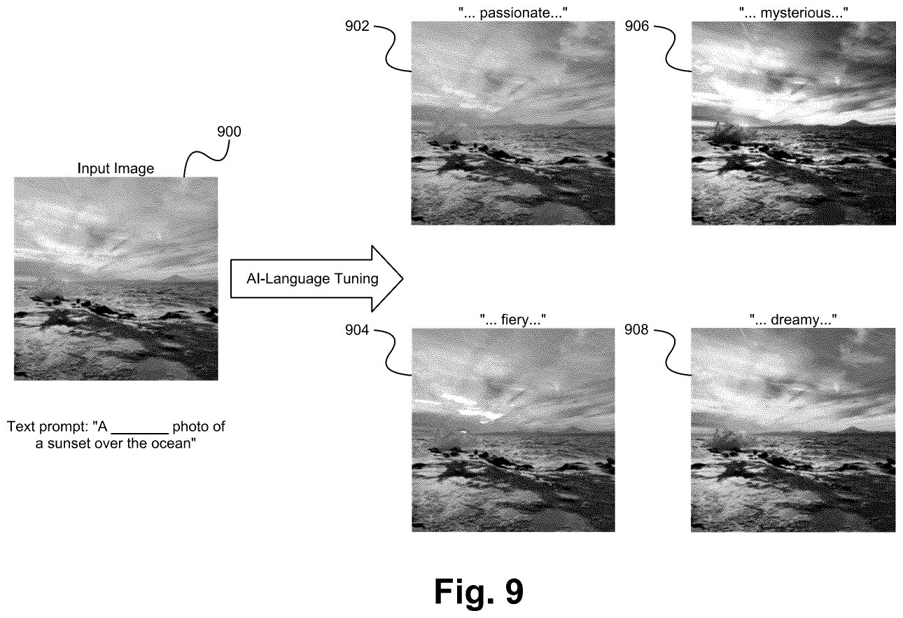

FIG. 9 shows images based on abstract and emotional prompts according to some embodiments. An n-parameter (e.g., n=6) color adjustment ISP block is able to be used adjust the color/appearance of images based on abstract and emotional prompts. A prompt of: “A ______ photo of a sunset over the ocean” is able to be used. An original image 800 is acquired. Based on the AI-language tuning, additional images are able to be adjusted to match the abstract or emotional prompt. Image 902 shows a “passionate” photo. Image 904 shows a “fiery” photo. Image 906 shows a “mysterious” photo. Image 908 shows a “dreamy” photo.

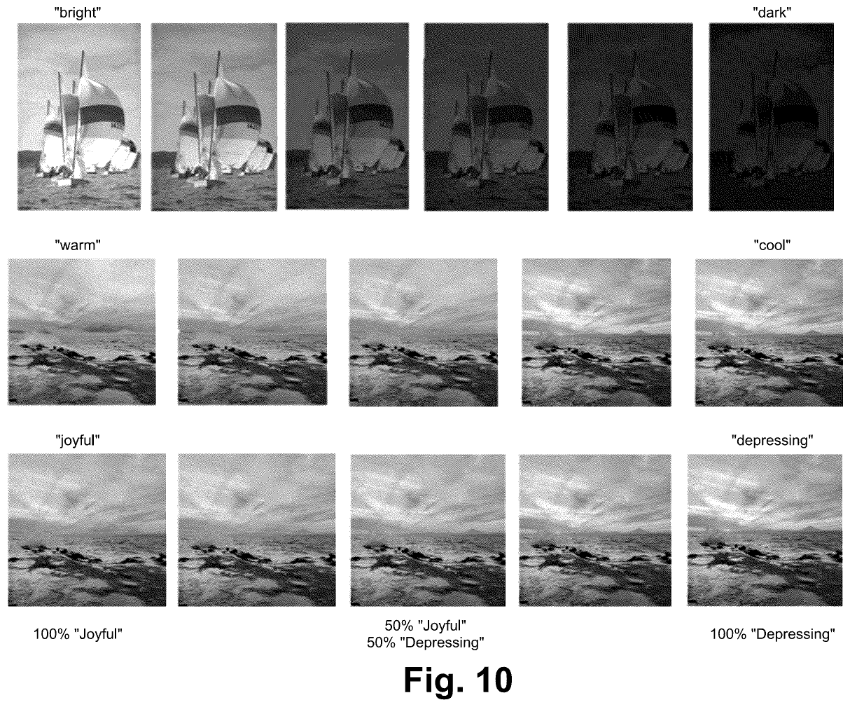

FIG. 10 shows images of ranges of image interpolation according to some embodiments. There are parameters which are the opposite ends of the spectrum when specific antonyms are used. For example, the words: bright/dark, warm/cool, and joyful/depressing are antonyms. When used, the same original image will look very different depending on which word is used. Additionally, there are able to be implementations where the parameters are in between the opposite ends of the spectrum. For example, if a luminance parameter for “bright” is 255, and the luminance parameter for “dark” is 0, a user is able to use relative terms or numbers which will adjust the luminance parameter to an amount in between. For example, the user could say “50% dark” which is in the middle of bright and dark, or “partly dark” which is 75% dark. Any other language/number variations are possible to adjust the parameters.

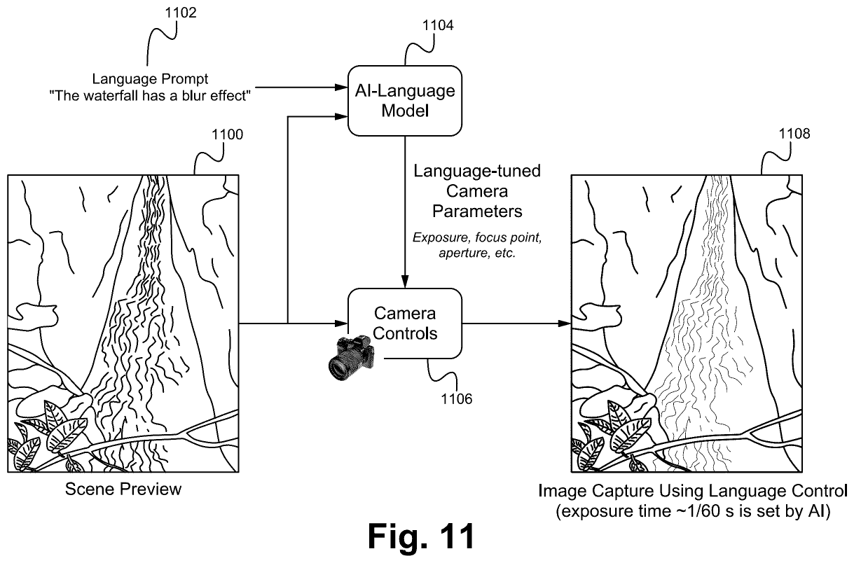

FIG. 11 shows a diagram of language-based camera controls according to some embodiments. The AI-based language model is able to generate camera control parameters matching a user prompt. A scene preview 1100 is able to be seen on or through the camera device. For example, in the scene preview 1100, the waterfall is clear and in focus. The user is able to provide a language prompt 1102 such as “the waterfall has a blur effect” or “autofocus on player #23.” An AI-language model 1104 receives the scene preview 1100 and language prompt 1102 to determine/adjust language-tuned camera control parameters (e.g., exposure, focus point, aperture). The adjusted control parameters are then used to adjust the camera controls 1106. With the adjusted camera controls, the camera device acquires the image 1108 (e.g., for a waterfall with a blur effect, the exposure time is ˜ 1/60 s). The image 1108 includes a waterfall with a blur effect.

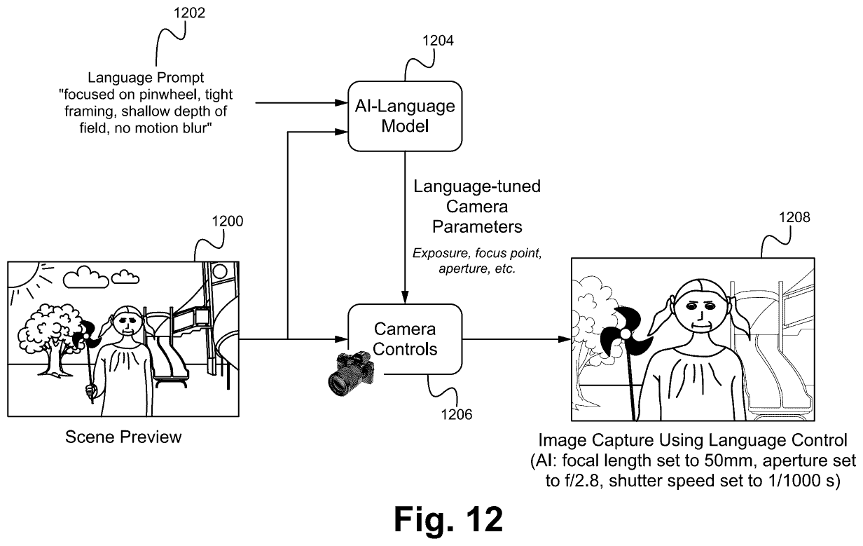

FIG. 12 shows a diagram of language-based camera controls according to some embodiments. A scene preview 1200 is able to be seen on or through the camera device. In the scene preview 1200, the foreground and background are in focus with a broad view of the scene. The user is able to provide a language prompt 1202 such as “focused on pinwheel, tight framing, shallow depth of field, no motion blur.” An AI-language model 1204 receives the scene preview 1200 and language prompt 1202 to determine/adjust language-tuned camera control parameters (e.g., exposure, focus point, aperture). The adjusted control parameters are then used to adjust the camera controls 1206. With the adjusted camera controls, the camera device acquires the image 1208 (e.g., the focal length is set to 50 mm, aperture is set to f/2.8, shutter speed set to 1/1000 s). The image 1208 is zoomed in, with the foreground in focus and the background out of focus.

In some embodiments, the user command is provided after an image is acquired to improve a second image. For example, a user takes a picture and then says “focus on the birthday boy.” The camera is then able to adjust parameters so that the focus is on the birthday boy, and a second picture is taken using those adjusted parameters. In another example, a user takes a landscape picture, but does not like the picture, so the user states, “make the grass greener,” and the camera adjusts the settings such that the grass is greener in the next picture.

In some embodiments, the camera parameter generation system generates parameter settings for the ISP only, camera controls only, or both the ISP and camera controls simultaneously.

In some embodiments, the camera parameter generation system uses as input: the captured image and language prompt, a pre-captured image and the language prompt, or the language prompt only.

The input language prompt is able to be spoken, text, or input in another manner. The input language prompt is able to be a single word, a few words or a sentence, a paragraph, or any level of input. In some embodiments, the input language prompt is a single prompt. In some embodiments, the input language prompt includes N prompts, where N>1 (e.g., a prompt and its antonym) along with a user-specified ratio between them. The generated parameters are an interpolation between the two prompts relative to the specified ratio which gives the user finer control over the final visual quality.

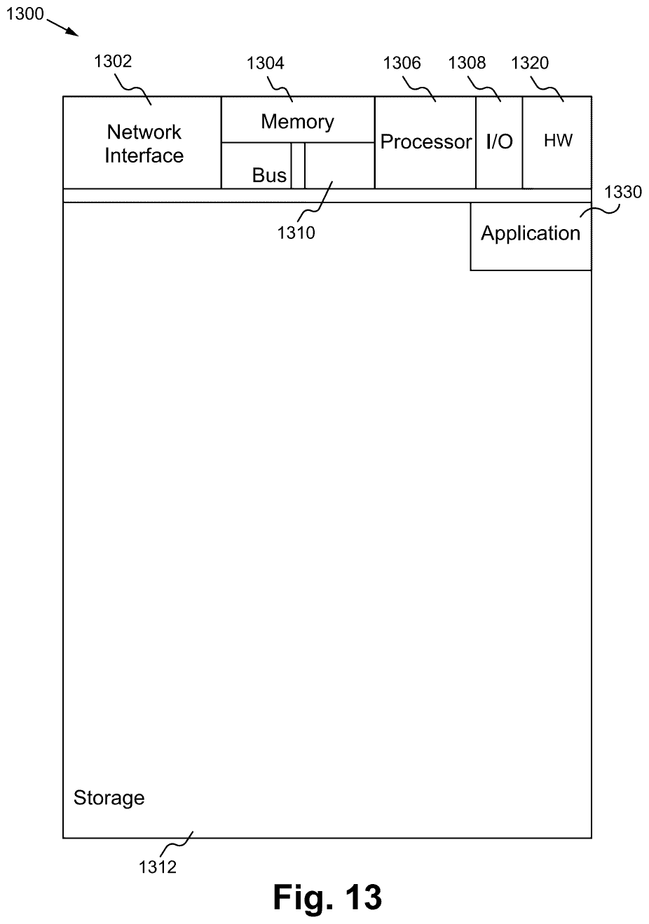

FIG. 13 shows a block diagram of an exemplary computing device configured to implement the AI-language-based camera parameter generation system according to some embodiments. The computing device 1300 is able to be used to acquire, store, compute, process, communicate and/or display information such as images and videos. The computing device 1300 is able to implement any of the camera parameter generation aspects. In general, a hardware structure suitable for implementing the computing device 1300 includes a network interface 1302, a memory 1304, a processor 1306, I/O device(s) 1308, a bus 1310 and a storage device 1312. The choice of processor is not critical as long as a suitable processor with sufficient speed is chosen. The memory 1304 is able to be any conventional computer memory known in the art. The storage device 1312 is able to include a hard drive, CDROM, CDRW, DVD, DVDRW, High Definition disc/drive, ultra-HD drive, flash memory card or any other storage device. The computing device 1300 is able to include one or more network interfaces 1302. An example of a network interface includes a network card connected to an Ethernet or other type of LAN. The I/O device(s) 1308 are able to include one or more of the following: keyboard, mouse, monitor, screen, printer, modem, touchscreen, button interface and other devices. Camera parameter generation application(s) 1330 used to implement the camera parameter generation are likely to be stored in the storage device 1312 and memory 1304 and processed as applications are typically processed. More or fewer components shown in FIG. 13 are able to be included in the computing device 1300. In some embodiments, camera parameter generation hardware 1320 is included. Although the computing device 1300 in FIG. 13 includes applications 1330 and hardware 1320 for the camera parameter generation, the camera parameter generation is able to be implemented on a computing device in hardware, firmware, software or any combination thereof. For example, in some embodiments, the camera parameter generation applications 1330 are programmed in a memory and executed using a processor. In another example, in some embodiments, the camera parameter generation hardware 1320 is programmed hardware logic including gates specifically designed to implement the camera parameter generation.

In some embodiments, the camera parameter generation application(s) 1330 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, an augmented reality device, a virtual reality device, smart jewelry (e.g., smart watch), a vehicle (e.g., a self-driving vehicle) or any other suitable computing device.

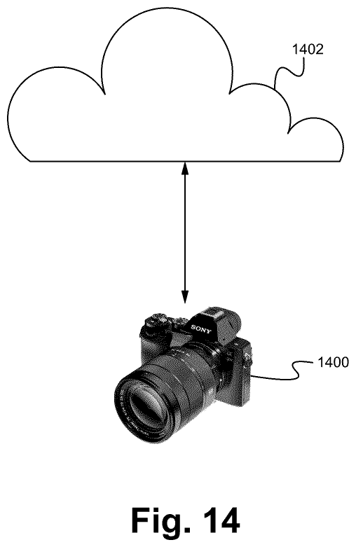

FIG. 14 shows a diagram of an exemplary AI-language-based camera parameter generation system according to some embodiments. As described herein, the camera parameter generation system is able to be implemented locally on a device, remotely on a Cloud device or a combination thereof. For example, the camera parameter generation system is implemented on a camera device 1400 (e.g., a camera or a camera phone). In another example, the camera parameter generation system is implemented on a cloud device 1402 by receiving inputs such as a user command and a RAW image. In another example, aspects of the camera parameter generation system are implemented on the camera device 1400 (e.g., generating the parameters), and aspects of the camera parameter generation system are implemented on the cloud device 1402 (e.g., training the AI model). In another example, a second camera device or handheld device (e.g., mobile phone) is utilized such that there is a camera device 1400, a mobile phone, and a cloud device 1402. Aspects of the camera parameter generation system are implemented on the camera device 1400, the mobile phone, and/or the cloud device 1402 (e.g., training the AI model). Any aspect of the camera parameter generation system is able to be implemented on any device.

Although the camera parameter generation system described herein utilizes AI, the system is able to be implemented without AI. For example, the system is able to use charts, tables, databases which link settings and language commands without the use of AI.

To utilize the camera parameter generation system and method described herein, devices such as a camera or camera phone are used to acquire content. The camera parameter generation is able to be implemented with user involvement or automatically without user involvement.

In operation, the camera parameter generation system and method uses AI to tune camera parameters to improve the quality of the photographs taken. The camera parameter generation method is able to retrieve a verbal input from a user, process the input and then adjust the camera parameters such that the desired photograph is acquired.

### Some Embodiments of AI-Language-Based Camera Parameter Generation System

1. A method programmed in a non-transitory memory of a device comprising:
   acquiring a language prompt;
   generating language-tuned camera settings based on the language prompt alone; and
   processing image sensor data based on the language-tuned camera settings to generate a language-processed image.
2. The method of clause 1 wherein generating the language-tuned camera settings is based on the language prompt and acquired sensor data.
3. The method of clause 1 wherein generating the language-tuned camera settings is performed through iterative interactions between the method and an operator of the device.
4. The method of clause 1 wherein the language-tuned camera settings comprise Image Signal Processor (ISP) parameters.
5. The method of clause 1 wherein the language-tuned camera settings comprise camera control parameters.
6. The method of clause 1 wherein the language-tuned camera settings comprise Image Signal Processor (ISP) parameters and camera control parameters.
7. The method of clause 1 wherein generating language-tuned camera settings is performed by an Artificial Intelligence (AI)-language model.
8. The method of clause 7 wherein the AI-language model is trained with images and corresponding language.
9. The method of clause 1 wherein the input image comprises a pre-captured image.
10. The method of clause 1 wherein the language prompt comprises speech or text.
11. The method of clause 1 wherein the language prompt comprises a single word, a fragment, a sentence or a paragraph.
12. The method of clause 1 wherein the language prompt comprises N prompts, where N>1, including a prompt and an antonym of the prompt and a user-specified ratio.
13. An apparatus comprising:
   a sensor for acquiring an input image;
   a non-transitory memory for storing an application, the application for:
      acquiring a language prompt; and
      generating language-tuned camera settings based on the language prompt and the input image;
   a processor coupled to the memory, the processor for processing the application; and
   an Image Signal Processor (ISP) for processing the input image based on the language-tuned camera settings to generate a language-processed image.
14. The apparatus of clause 13 wherein generating the language-tuned camera settings is based on the language prompt and acquired sensor data.
15. The apparatus of clause 13 wherein generating the language-tuned camera settings is performed through iterative interactions between the apparatus and an operator of the apparatus.
16. The apparatus of clause 13 wherein the language-tuned camera settings comprise ISP parameters.
17. The apparatus of clause 13 wherein the language-tuned camera settings comprise camera control parameters.
18. The apparatus of clause 13 wherein the language-tuned camera settings comprise ISP parameters and camera control parameters.
19. The apparatus of clause 13 wherein generating language-tuned camera settings is performed by an Artificial Intelligence (AI)-language model.
20. The apparatus of clause 19 wherein the AI-language model is trained with images and corresponding language.
21. The apparatus of clause 13 wherein the input image comprises a pre-captured image.
22. The apparatus of clause 13 wherein the language prompt comprises speech or text.
23. The apparatus of clause 13 wherein the language prompt comprises a single word, a fragment, a sentence or a paragraph.
24. The apparatus of clause 13 wherein the language prompt comprises N prompts, where N>1, including a prompt and an antonym of the prompt and a user-specified ratio.
25. A system comprising:
   a camera device configured for:
      acquiring a language prompt; and
      processing image sensor data based on the language-tuned camera settings to generate a language-processed image; and
   a cloud device configured for:
      receiving the language prompt from the camera device;
      generating the language-tuned camera settings based on the language prompt alone; and
      sending the language-tuned camera settings to the camera device.
26. The system of clause 25 wherein generating the language-tuned camera settings is based on the language prompt and acquired sensor data.
27. The system of clause 25 wherein generating the language-tuned camera settings is performed through iterative interactions between the camera device and an operator of the camera device.
28. The system of clause 25 wherein the language-tuned camera settings comprise ISP parameters.
29. The system of clause 25 wherein the language-tuned camera settings comprise camera control parameters.
30. The system of clause 25 wherein the language-tuned camera settings comprise ISP parameters and camera control parameters.
31. The system of clause 25 wherein generating language-tuned camera settings is performed by an Artificial Intelligence (AI)-language model.
32. The system of clause 31 wherein the AI-language model is trained with images and corresponding language.
33. The system of clause 25 wherein the input image comprises a pre-captured image.
34. The system of clause 25 wherein the language prompt comprises speech or text.
35. The system of clause 25 wherein the language prompt comprises a single word, a fragment, a sentence or a paragraph.
36. The system of clause 25 wherein the language prompt comprises N prompts, where N>1, including a prompt and an antonym of the prompt and a user-specified ratio.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
acquiring a language prompt;
generating language-tuned camera settings based on the language prompt alone; and
processing image sensor data based on the language-tuned camera settings to generate a language-processed image.

2. The method of claim 1 wherein generating the language-tuned camera settings is based on the language prompt and acquired sensor data.

3. The method of claim 1 wherein generating the language-tuned camera settings is performed through iterative interactions between the method and an operator of the device.

4. The method of claim 1 wherein the language-tuned camera settings comprise Image Signal Processor (ISP) parameters.

5. The method of claim 1 wherein the language-tuned camera settings comprise camera control parameters.

6. The method of claim 1 wherein the language-tuned camera settings comprise Image Signal Processor (ISP) parameters and camera control parameters.

7. The method of claim 1 wherein generating language-tuned camera settings is performed by an Artificial Intelligence (AI)-language model.

8. The method of claim 7 wherein the AI-language model is trained with images and corresponding language.

9. The method of claim 1 wherein the input image comprises a pre-captured image.

10. The method of claim 1 wherein the language prompt comprises speech or text.

11. The method of claim 1 wherein the language prompt comprises a single word, a fragment, a sentence or a paragraph.

12. The method of claim 1 wherein the language prompt comprises N prompts, where N>1, including a prompt and an antonym of the prompt and a user-specified ratio.

13. An apparatus comprising:
a sensor for acquiring an input image;
a non-transitory memory for storing an application, the application for:
acquiring a language prompt; and
generating language-tuned camera settings based on the language prompt and the input image;
a processor coupled to the memory, the processor for processing the application; and
an Image Signal Processor (ISP) for processing the input image based on the language-tuned camera settings to generate a language-processed image.

14. The apparatus of claim 13 wherein generating the language-tuned camera settings is based on the language prompt and acquired sensor data.

15. The apparatus of claim 13 wherein generating the language-tuned camera settings is performed through iterative interactions between the apparatus and an operator of the apparatus.

16. The apparatus of claim 13 wherein the language-tuned camera settings comprise ISP parameters.

17. The apparatus of claim 13 wherein the language-tuned camera settings comprise camera control parameters.

18. The apparatus of claim 13 wherein the language-tuned camera settings comprise ISP parameters and camera control parameters.

19. The apparatus of claim 13 wherein generating language-tuned camera settings is performed by an Artificial Intelligence (AI)-language model.

20. The apparatus of claim 19 wherein the AI-language model is trained with images and corresponding language.

21. The apparatus of claim 13 wherein the input image comprises a pre-captured image.

22. The apparatus of claim 13 wherein the language prompt comprises speech or text.

23. The apparatus of claim 13 wherein the language prompt comprises a single word, a fragment, a sentence or a paragraph.

24. The apparatus of claim 13 wherein the language prompt comprises two prompts including a prompt and an antonym of the prompt and a user-specified ratio.

25. A system comprising:
a camera device configured for:
acquiring a language prompt; and
processing image sensor data based on the language-tuned camera settings to generate a language-processed image; and
a cloud device configured for:
receiving the language prompt from the camera device;
generating the language-tuned camera settings based on the language prompt alone; and
sending the language-tuned camera settings to the camera device.

26. The system of claim 25 wherein generating the language-tuned camera settings is based on the language prompt and acquired sensor data.

27. The system of claim 25 wherein generating the language-tuned camera settings is performed through iterative interactions between the camera device and an operator of the camera device.

28. The system of claim 25 wherein the language-tuned camera settings comprise ISP parameters.

29. The system of claim 25 wherein the language-tuned camera settings comprise camera control parameters.

30. The system of claim 25 wherein the language-tuned camera settings comprise ISP parameters and camera control parameters.

31. The system of claim 25 wherein generating language-tuned camera settings is performed by an Artificial Intelligence (AI)-language model.

32. The system of claim 31 wherein the AI-language model is trained with images and corresponding language.

33. The system of claim 25 wherein the input image comprises a pre-captured image.

34. The system of claim 25 wherein the language prompt comprises speech or text.

35. The system of claim 25 wherein the language prompt comprises a single word, a fragment, a sentence or a paragraph.

36. The system of claim 25 wherein the language prompt comprises two prompts including a prompt and an antonym of the prompt and a user-specified ratio.
